(19) United States
(12) Patent Application Publication
(10) Pub. No.: US 2015/0315927 A1
(43) Pub. Date: Nov. 5, 2015

(54) ENHANCED GENERATOR CAPABILITY IN HOT AMBIENT TEMPERATURES

(71) Applicant: General Electric Company, Schenectady, NY (US)

(72) Inventors: Joseph John, Bangalore (IN); Bhaskar Pemmi, Bangalore (IN); Balamurugan Sridharan, Bangalore (IN)

(73) Assignee: General Electric Company, Schenectady, NY (US)

(21) Appl. No.: 14/267,369

(22) Filed: May 1, 2014

(51) Int. Cl. F01D 15/10; H02K 9/19

(52) U.S. Cl. CPC F01D 15/10; H02K 9/19

(57) ABSTRACT

A gas turbine includes a compressor, a combustor, a turbine, and a generator disposed upstream of the compressor. The gas turbine also includes a heat exchange circuit with a generator cooler circuit cooperable with the generator and circulating a coolant in the generator. The heat exchange circuit also includes a water circuit circulating water in a heat exchange relationship with the generator cooler circuit. The coolant in the generator cooler circuit is cooled by the water in the water circuit.

### BACKGROUND OF THE INVENTION

The invention relates generally to gas turbines and, more particularly, to a gas turbine including a heat exchange circuit utilizing cold energy for a coolant in a generator.

Gas turbines are widely used in commercial operations for power generation. FIG. 1 illustrates a typical gas turbine 10 known in the art. As shown in FIG. 1, the gas turbine 10 generally includes a compressor 12 at the front, one or more combustors 14 around the middle, and a turbine 16 at the rear. The compressor 12 and the turbine 16 typically share a common rotor. The compressor 12 progressively compresses a working fluid and discharges the compressed working fluid to the combustors 14. The combustors 14 inject fuel into the flow of compressed working fluid and ignite the mixture to produce combustion gases having a high temperature, pressure, and velocity. The combustion gases exit the combustors 14 and flow to the turbine 16 where they expand to produce work.

In an environment with hot ambient temperatures, the cooling water inlet to a generator can be higher than desired, thereby reducing the heat load and generator capability. For example, with high ambient temperatures around 55° C. (about 130° F.), the cooling water inlet to the generator will be 60° C. (about 140° F.), and the exit temperature will be about 65° C. (about 150° F.). Due to these high temperatures, the heat loads carried by the coolers are reduced, thereby reducing the capability of generators in the warmer climates. Even if the gas turbine is capable of producing higher output, due to reduced generator capability, the output may be limited.

It would be desirable to find a source of cold energy to reduce a temperature of the coolant in the generator.

In recent years, natural gas fuel prices have continued to increase dramatically, forcing combustion turbine power plants to explore alternatives to natural gas fuels. Many power plants are evaluating use of alternate fuels such as liquefied natural gas (LNG). The LNG is stored in a cylinder in liquid form at very low temperatures (e.g., about −260° F. to −160° F.) under pressure (about 400 psia). Also, in warm climates, gas turbine sites may be equipped with an inlet chiller to enhance performance during a hot day.

### BRIEF DESCRIPTION OF THE INVENTION

In an exemplary embodiment, a gas turbine includes a compressor, a combustor, a turbine, and a generator disposed upstream of the compressor. The gas turbine also includes a heat exchange circuit with a generator cooler circuit cooperable with the generator and circulating a coolant for cooling the generator, and with a water circuit circulating water in a heat exchange relationship with the generator cooler circuit. The coolant in the generator cooler circuit is cooled by the water in the water circuit.

In another exemplary embodiment, a heat exchange circuit is cooperable in a gas turbine and a generator. The heat exchange circuit includes a generator cooler circuit disposed upstream of the gas turbine compressor. The generator cooler circuit circulating a cooling medium to cool the generator. A cooling source containing fuel is coupled with a supply line that delivers the fuel to the one or more combustors. A water circuit circulating water includes a first section in a heat exchange relationship with the generator cooler circuit and a second section in a heat exchange relationship with a section of the supply line. The water in the water circuit is cooled by the fuel in the supply line, the cooling medium in the generator cooler circuit is cooled by the water in the water circuit, and the fuel is heated by the water in the water circuit. Subsequently, the supply line directs the heated fuel to the one or more combustors of the gas turbine.

In yet another exemplary embodiment, a gas turbine includes a compressor, a combustor receiving compressed air from the compressor, a turbine receiving combustion gases from the combustor, and a generator sharing a rotor with the turbine. A fuel source is in fluid communication with the combustor by a fuel supply line. The combustor injects fuel from the fuel source into the compressed air from the compressor and ignites the mixture to produce the combustion gases. The turbine also includes a heat exchange circuit with a generator cooler circuit disposed upstream of the compressor that circulates a cooling medium to cool the generator, and with a water circuit that circulates water. The water circuit includes a first section in a heat exchange relationship with the generator cooler circuit and a second section in a heat exchange relationship with a section of the fuel supply line. The water in the water circuit is cooled by the fuel in the supply line, the cooling medium in the generator cooler circuit is cooled by the water in the water circuit, and the fuel is heated by the water in the water circuit. The supply line subsequently directs the heated fuel to the combustor.

### BRIEF DESCRIPTION OF THE DRAWINGS

FIG. 1 is a schematic illustration of a typical gas turbine;

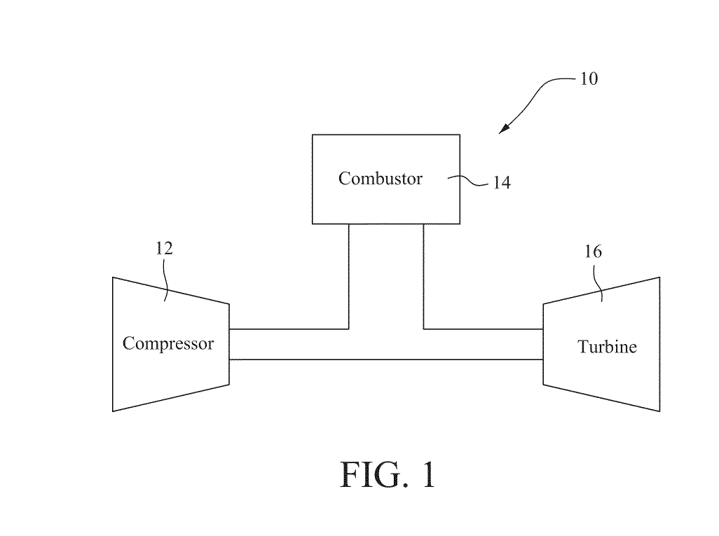

FIG. 2 shows a gas turbine including a heat exchange circuit using cold energy from LNG; and

FIG. 3 is a gas turbine using cold energy from inlet chiller condensate.

### DETAILED DESCRIPTION OF THE INVENTION

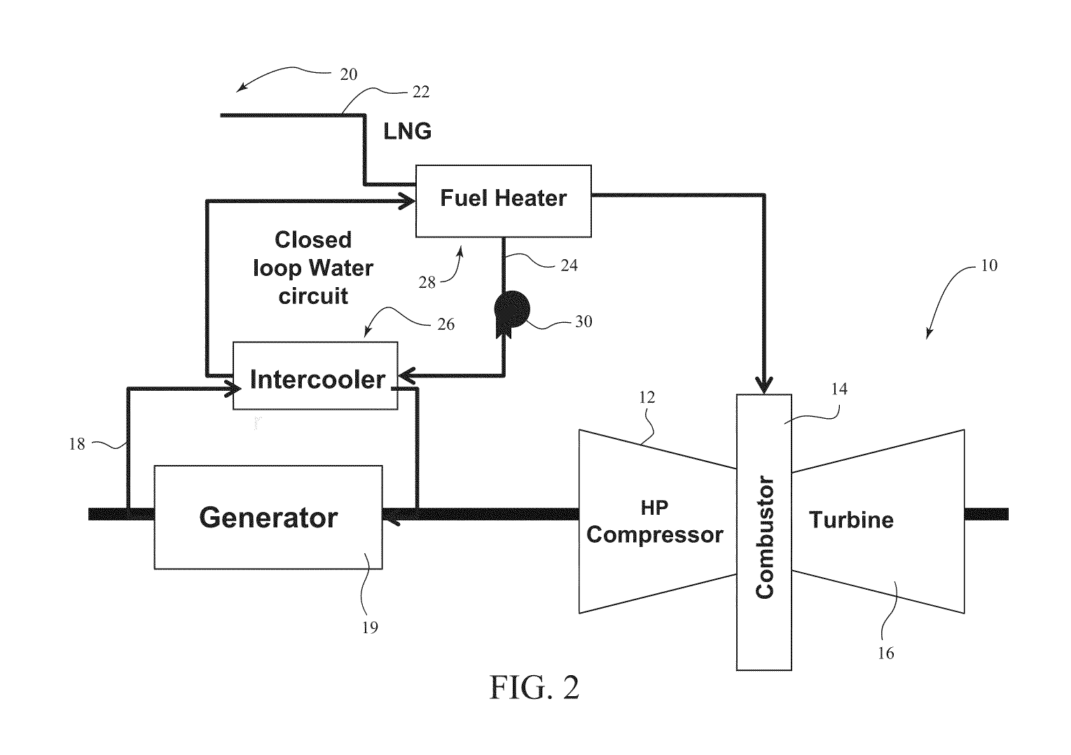

Both the LNG and condensate from the inlet chiller can be a source of cold energy for cooling. In FIG. 2, a generator cooler circuit 18 for cooling a generator 19 is disposed upstream of the compressor 12. The generator 19 helps in providing the power generated by the gas turbine 10 to the grid. In doing so, the generator 19 produces heat, and an embedded cooling system with coolant as hydrogen/air via the generator cooler circuit 18 is utilized to cool the generator 19. Typically, the generator 19, compressor 12 and turbine 16 share a common rotor.

Cold energy in the embodiment shown in FIG. 2 is provided by a source 20 of LNG fuel. The source 20 is coupled with a supply line 22 that delivers the fuel to the one or more combustors 14 of the gas turbine 10.

A water circuit 24 circulates water and includes a first section or intercooler 26 in a heat exchange relationship with the generator cooler circuit 18 and a second section or fuel heater 28 in a heat exchange relationship with a section of the supply line 22. A pump 30 circulates water in the water circuit 24.

In use, the water in the water circuit 24 is cooled by the fuel in the supply line 22. The cooling medium in the generator cooler circuit 18 is cooled by the water in the water circuit 24. The fuel is heated by the water in the water circuit 24, and the supply line 22 directs the heated fuel to the one or more combustors 14 of the gas turbine 10.

Preferably, the fuel is LNG. The LNG is at a very low temperature (about −260° F. to −160° F.), depending on the pressure of the storage to keep it in a liquefied state. For power generation, the LNG is gasified by releasing the pressure, and the LNG is heated to a desirable temperature for combustion in the turbine combustor (about 80° F. to 120° F.)

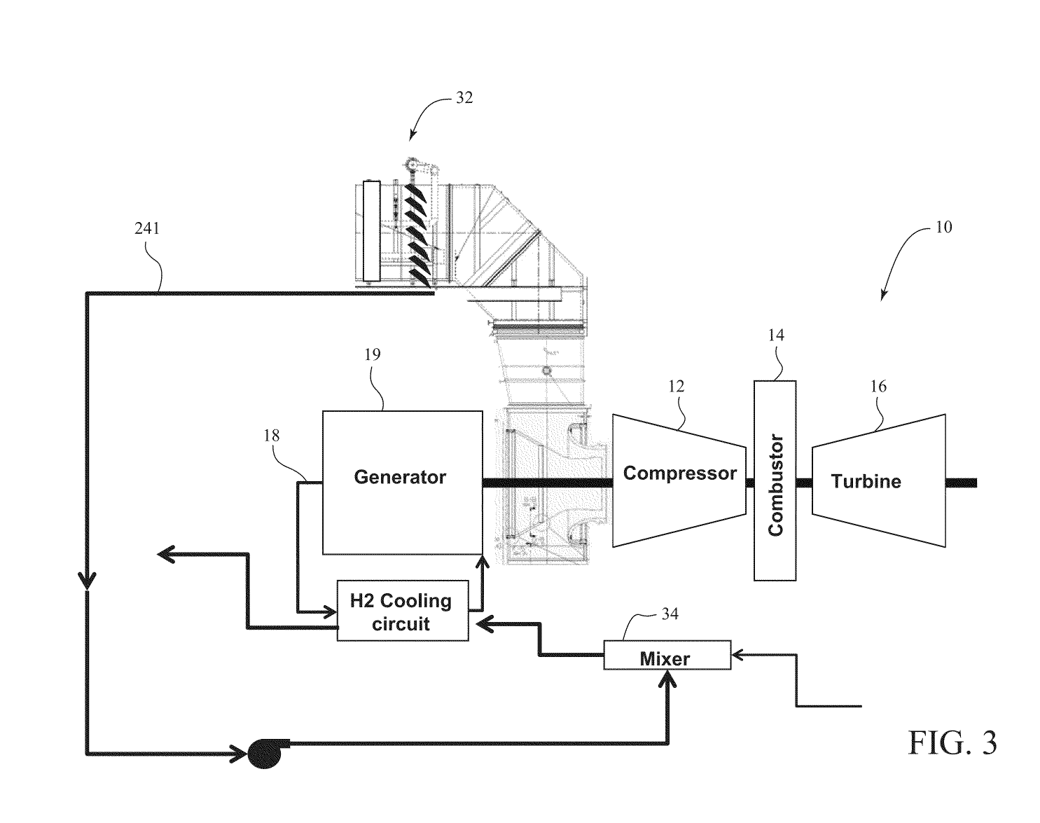

FIG. 3 shows an alternative embodiment utilizing inlet chiller condensate as a source of cold energy. The gas turbine 10 in this embodiment includes an inlet chiller 32. As noted above, the inlet chiller 32 enhances performance during a hot day. The inlet chiller is interposed between the generator 19 and the compressor 12. The water circuit 241 in this embodiment receives condensate from the inlet chiller 32 and includes a mixer 34 that mixes the chiller condensate with an outside cooling medium such as water from a cooling tower, river, or the like. The water circuit 241 is in a heat exchange relationship with the generator cooler circuit 18, and the coolant in the generator cooler circuit 18 is cooled by the water in the water circuit after the mixer 34.

Cooling generator performance can be enhanced by the exchange of cold energy from a cold energy source. In preferred embodiments, the cooled energy source may be LNG fuel or condensate from an inlet chiller.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A gas turbine comprising:
a compressor;
a combustor receiving compressed air from the compressor;
a turbine receiving combustion gases from the combustor;
a generator disposed upstream of the compressor; and
a heat exchange circuit, including:
a generator cooler circuit cooperable with the generator and circulating a coolant for cooling the generator, and
a water circuit circulating water in a heat exchange relationship with the generator cooler circuit,
wherein the coolant in the generator cooler circuit is cooled by the water in the water circuit.

2. A gas turbine according to claim 1, further comprising an inlet chiller interposed between the generator and the compressor, wherein the water circuit comprises a mixer that mixes condensate from the inlet chiller with an outside cooling medium.

3. A gas turbine according to claim 2, wherein the coolant is hydrogen.

4. A gas turbine according to claim 1, further comprising a fuel source in fluid communication with the combustor by a fuel supply line, wherein the combustor injects fuel from the fuel source into the compressed air from the compressor and ignites the mixture to produce the combustion gases, wherein the water circuit comprises a first section in a heat exchange relationship with the generator cooler circuit and a second section in a heat exchange relationship with a section of the fuel supply line.

5. A heat exchange circuit cooperable in a gas turbine and a generator, the gas turbine including a compressor, one or more combustors, and a turbine, the heat exchange circuit comprising:
a generator cooler circuit disposed upstream of the compressor, the generator cooler circuit circulating a cooling medium to cool the generator;
a cooling source containing fuel, the cooling source being coupled with a supply line that delivers the fuel to the one or more combustors; and
a water circuit circulating water and including a first section in a heat exchange relationship with the generator cooler circuit and a second section in a heat exchange relationship with a section of the supply line,
wherein the water in the water circuit is cooled by the fuel in the supply line, wherein the cooling medium in the generator cooler circuit is cooled by the water in the water circuit, and wherein the fuel is heated by the water in the water circuit, the supply line directing the heated fuel to the one or more combustors of the gas turbine.

6. A heat exchange circuit according to claim 5, wherein the cooling medium in the generator cooler circuit is hydrogen or air.

7. A heat exchange circuit according to claim 5, wherein the water circuit comprises a pump to circulate the water.

8. A heat exchange circuit according to claim 5, wherein the fuel comprises liquefied natural gas.

9. A heat exchange circuit according to claim 8, wherein the cooling source comprises a supply of liquefied natural gas stored under pressure in a cylinder.

10. A gas turbine comprising:
a compressor;
a combustor receiving compressed air from the compressor;
a turbine receiving combustion gases from the combustor;
a generator sharing a rotor with the turbine;
a fuel source in fluid communication with the combustor by a fuel supply line, wherein the combustor injects fuel from the fuel source into the compressed air from the compressor and ignites the mixture to produce the combustion gases; and
a heat exchange circuit, including:
a generator cooler circuit disposed upstream of the compressor, the generator cooler circuit circulating a cooling medium to cool the generator, and
a water circuit circulating water and including a first section in a heat exchange relationship with the generator cooler circuit and a second section in a heat exchange relationship with a section of the fuel supply line,
wherein the water in the water circuit is cooled by the fuel in the supply line, wherein the cooling medium in the generator cooler circuit is cooled by the water in the water circuit, and wherein the fuel is heated by the water in the water circuit, the supply line directing the heated fuel to the combustor.

11. A gas turbine circuit according to claim 10, wherein the cooling medium in the generator cooler circuit is hydrogen.

12. A gas turbine circuit according to claim 10, wherein the water circuit comprises a pump to circulate the water.

13. A gas turbine circuit according to claim 10, wherein the fuel comprises liquefied natural gas.

14. A gas turbine circuit according to claim 13, wherein the cooling source comprises a supply of liquefied natural gas stored under pressure in a cylinder.
